(19) United States
(12) Patent Application Publication
(10) Pub. No.: US 2008/0219792 A1
(43) Pub. Date: Sep. 11, 2008

(54) Method for correcting tool gripper

(75) Inventor: Peter Chen, Taoyuan County (TW)

Correspondence Address: Joe McKinney Muncy, PO Box 1364, Fairfax, VA, 22038-1364, US

(73) Assignee: Primetool MFG, Inc.

(21) Appl. No.: 11/714,769

(22) Filed: Mar. 7, 2007

(51) Int. Cl. B23C 3/00; G01N 19/00

(52) U.S. Cl. 409/132; 73/865.9

(57) ABSTRACT

The present invention is disclosed for stabilizing a connection between the tool gripper and a driving shaft on a processing machine to prevent the vibration produced during the tool gripper being turning in a high speed from influencing the precision of the processing. In the method, firstly, an origin is positioned, and a distance between the bottom of the tool gripper and the bottom of the driving shaft is measured. Then, a standard length from the bottom of the tool gripper to the top of the rejecting portion is subtracted from the obtained distance for acquiring the distance of an interval between the bottom of the driving shaft and the top of the rejecting portion. Finally, for filling, a sleeve ring conforming to the interval between the driving shaft and the rejecting portion is mounted between the driving shaft and the rejecting portion.

### FIELD OF THE INVENTION

The present invention is related to a measuring method, and more particularly to a method for correcting a tool gripper.

### BACKGROUND OF THE INVENTION

Currently, high precision metal processing procedure, such as drilling, reaming, boring, milling, cutting internal and external diameters, or surface polishing, always employs the CNC (Computer Numerical Control) processing machine to cooperate with multiple cutting tools or other tools. Generally, the cutting tool or tool may have a long steam structure, which is used for connecting to a driving shaft of the CNC processing machine via a gripper or gripping structure, and as the driving shaft proceeds a high speed turning, the cutting tool or tool gripped by the gripper can be driven to process the target object.

The conventional gripper 1, as shown in FIG. 1, is manufactured for public standard or for specific standards. However, during fabrication, the structure of the gripper 1 might have an error after procedures of processing and heat treatment, so that when the gripper is actually connected to the driving shaft 2 on the machine, they may not have a perfect match. Owing to the interval 3 between the gripper 1 and the driving shaft 2, the gripper 1 may produce a vibration when executing a high-speed turning, and since the higher the turning speed, the more the increment in vibration frequency, except the precision reduction in target object processing, the gripper 1 or the processing machine even might be damaged so as to cause an extra production cost.

A conventional tool gripping structure disclosed in U.S. patent application Ser. No. 11/450,579 includes a gripping component mounted on an assembling portion of a machine for fixing a tool, wherein the gripping component has a connecting backbone for connecting to the assembling portion and the bottom portion of the connecting backbone has an engaging portion whose outer diameter is larger than that of the connecting backbone, characterized in that a sleeve ring is mounted between the engaging portion and the surface of the assembling portion and the sleeve ring is tightly matched to the engaging portion and the assembling portion. In this embodiment, the sleeve ring fills up the interval between the gripper and the driving shaft so as to avoid the gripper from vibration as turning in high speed. However, different sleeve rings may have different intervals with the driving shaft, so that if only one single standard of sleeve ring is employed, then the problem that the vibrations from different grippers can not be totally solved still exists.

### SUMMARY OF THE INVENTION

The object of the present invention is to prevent the vibration caused from the gripper being not tightly matched with the driving shaft of the machine from influencing the precision of the processing tool or tool when a high-speed turning processing is proceeded.

For achieving the object, the present invention provides a method for correcting a tool gripper so as to stabilize a connection between the tool gripper and a driving shaft on a processing machine. Firstly, an origin is positioned, and a distance between the bottom of the tool gripper and the bottom of the driving shaft is measured. Then, a standard length from the bottom of the tool gripper to the top of the rejecting portion is subtracted from the distance between the bottom of the tool gripper and the bottom of the driving shaft for obtaining the distance of an interval between the bottom of the driving shaft and the top of the rejecting portion. Finally, a sleeve ring, which conforms to the distance between the bottom of the driving shaft and the top of the rejecting portion, is mounted at the interval between the driving shaft and the rejecting portion. For fixing the sleeve ring, the sleeve ring can be adhered to the rejecting portion, or the rejecting portion can have a screw hole and the sleeve ring has a through hole at the position corresponding to the screw hole, so that the sleeve ring can be fixed on the rejecting portion through penetrating a bolt through the through hole and then screwing thereof in the screw hole. The method for correcting the tool gripper according to the present invention is easy to operate and can accurately conform to the corrections of tool grippers in different standards, and without additionally buying other expensive measuring instruments, the distance of the interval between the driving shaft and the rejecting portion can be precisely measured. Furthermore, the sleeve ring also can be processed or selected to have a proper dimension for conforming to the demands of different thicknesses without destroying the structure of the driving shaft or the tool gripper.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a schematic view showing the combination of a conventional tool gripper and a driving shaft;

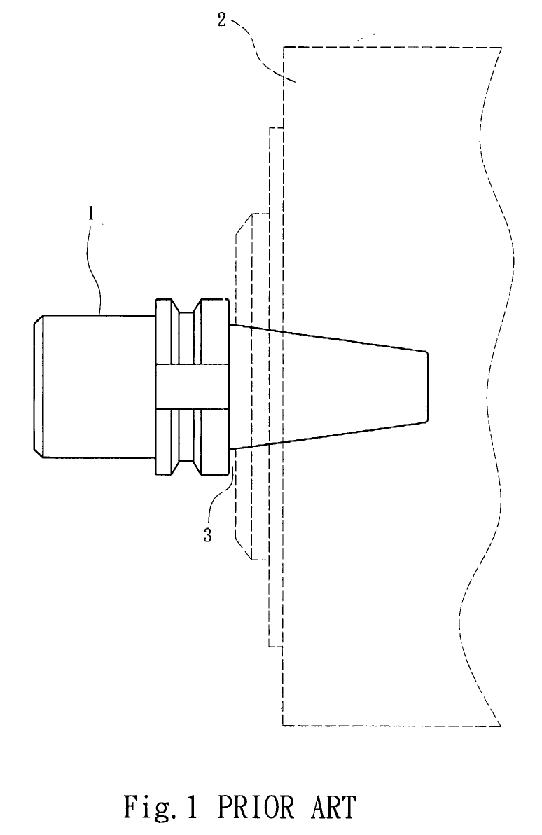

FIG. 2 is a flow chart showing a method for correcting a tool gripper according to the present invention;

FIG. 3 is a combinational schematic view showing a method for correcting a tool gripper according to the present invention; and

FIG. 4 is a combinational schematic view showing a method for correcting a tool gripper in (,mother embodiment according to the present invention.

### DESCRIPTION OF THE PREFERRED EMBODIMENT

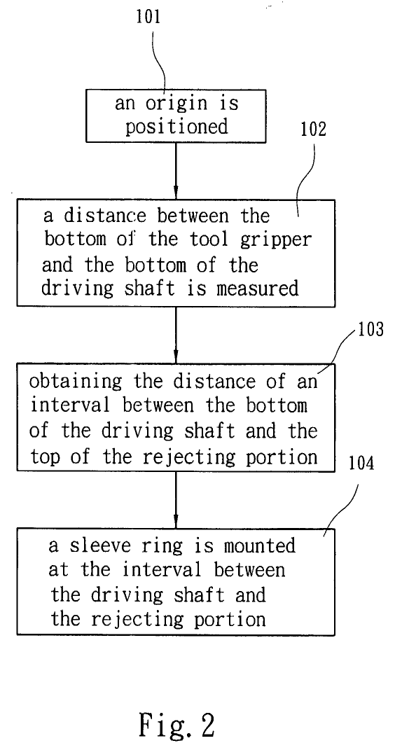

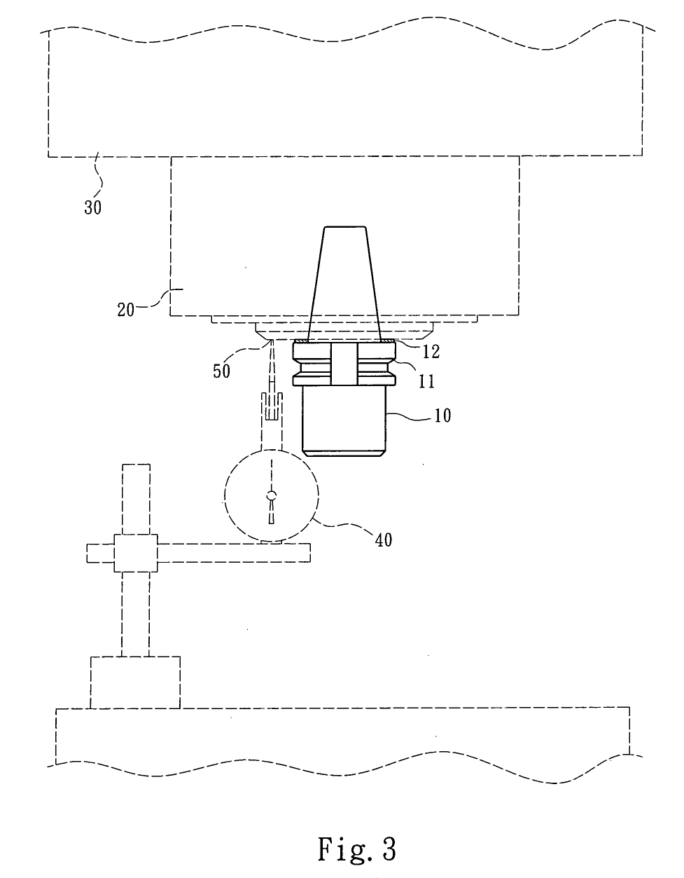

Please refer to FIGS. 2 and 3 which are respectively a flow chart and a combinational schematic view showing a method for correcting a tool gripper. As shown, a method for correcting a tool gripper is used to stabilize a connection between a tool gripper 10 and a driving shaft 20 of a processing machine (not shown), wherein the tool gripper 10 has a circular rejecting portion 11 extended from the surface thereof which is only close to but not tightly matched with the driving shaft 20, and the processing machine can control the position of the driving shaft 20 and owns a display (not shown) for showing the position of the driving shaft 20. In step 101, firstly, an origin is positioned and the tip of a zeroed micrometer (not shown) is aimed at the origin. In step 102, the bottom of the driving shaft 20 is positioned at the tip of the micrometer (as the micrometer is zeroed) and the value appeared on the display is also zeroed to present that the bottom of the driving shaft 20 is the position of the origin. Then, the tool gripper 10 is mounted on the driving shaft 20, and after the bottom of the tool gripper 10 is positioned at the tip of the micrometer (as the micrometer is also zeroed), the value appeared on the display namely represents the distance between the bottom of the tool gripper 10 and the bottom of the driving shaft 20. In step 103, a standard length from the bottom of the tool gripper 10 to the top of the rejecting portion 11 is subtracted from the distance between the bottom of the tool gripper 10 and the bottom of the driving shaft 20, and the distance of the interval between the bottom of the driving shaft 20 and the top of the rejecting portion 11 is obtained.

Since the interval between the bottom of the driving shaft 20 and the top of the rejecting portion 11 may cause a vibration of the tool gripper 10 when the driving shaft 20 of the machine proceeds a high speed turning, for solving this problem, in step 104 of the method for correcting the tool gripper according to the present invention, a sleeve ring 12 is mounted at the interval between the driving shaft 20 and the rejecting portion 11, as shown in FIG. 3, and the sleeve ring 12 has been selected or processed to conform to the distance between the bottom of the driving shaft 20 and the top of the rejecting portion 11, so that the rejection portion 11 of the tool gripper 10, the sleeve ring 12 and the driving shaft 20 can have a tight match to each other so as to prevent the vibration problem during the high speed turning processing.

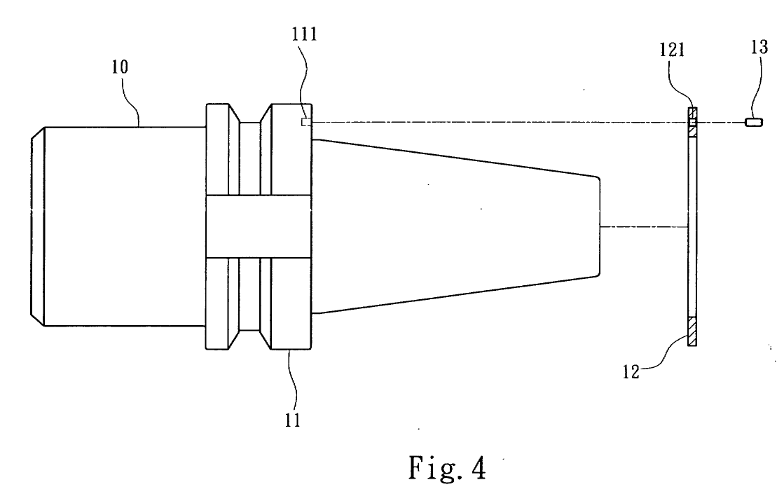

For stably positioning the sleeve ring 12 on the tool gripper 10, the sleeve ring 12 can be adhered to the rejecting portion 11, or as shown in FIG. 4, the rejecting portion 11 has a screw hole 111 and the sleeve ring has a through hole 121 at the position corresponding to the screw hole 111, so that the sleeve ring 12 can be fixed on the rejecting portion 11 through penetrating a bolt 13 through the through hole 121 and then screwing thereof in the screw hole 111.

The method for correcting tool gripper according to the present invention is to, firstly, measure the distance between the top of the rejecting portion 11 and the bottom of the driving shaft 20, and then, to sleeve a sleeve ring 12, which conforms to the distance, between the rejecting portion 11 and the driving shaft 20 so as to tightly match the rejecting portion 11, the sleeve ring 12 and the driving shaft 20. Therefore, the vibration of the tool gripper caused from the interval between the top of the rejecting portion 11 of the tool gripper 10 and the bottom of the driving shaft 20 when the processing machine proceeds a high speed turning processing can be solved.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A method for correcting a tool gripper so as to stabilize a connection between the tool gripper and a driving shaft on a processing machine, wherein the tool gripper has a rejecting portion extended from a surface thereof near a bottom of the driving shaft, the method comprising steps of:
defining a point at the bottom of the driving shaft as an origin;
measuring a distance between a bottom of the tool gripper and the bottom of the driving shaft;
subtracting a standard length from the bottom of the tool gripper to a top of the rejecting portion from the distance between the bottom of the tool gripper and the bottom of the driving shaft for obtaining a distance of an interval between the bottom of the driving shaft and the top of the rejecting portion; and
mounting a sleeve ring which conforms to a distance between the bottom of the driving shaft and the top of the rejecting portion, at an interval between the driving shaft and the rejecting portion.

2. The method according to claim 1, further comprising positioning a tip of a micrometer at the origin.

3. The method according to claim 1, wherein the distance between the bottom of the tool gripper and the bottom of the driving shaft is obtained by subtracting coordinates of the bottom of the tool gripper and the bottom of the driving shaft displayed on the processing machine.
